(19) United States
(12) Patent Application Publication
(10) Pub. No.: US 2011/0181032 A1
(43) Pub. Date: Jul. 28, 2011

(54) LAY-FLAT BOOK BLOCK HAVING LAY-FLAT PRE-CONVERTED PRINT STOCK AND METHOD OF MAKING THE SAME

(75) Inventor: Aric N. Snyder, Sedalia, MO (US)

(73) Assignee: CONVERTIBLE SOLUTIONS, LLC, Sedalia, MO (US)

(21) Appl. No.: 13/010,713

(22) Filed: Jan. 20, 2011

Related U.S. Application Data
(60) Provisional application No. 61/336,481, filed on Jan. 22, 2010.

(51) Int. Cl. B42D 1/00; B42C 9/00

(52) U.S. Cl. 281/21.1; 412/8

(57) ABSTRACT

A lay-flay book block having a lay-flat pre-converted print stock and a method of making a lay-flat book block are provided. The lay-flat book block includes a stack of pages, a cohesive and a graphic, text or image. Each page includes two sheets of the lay-flat pre-converted print stock that are folded along a centerline which divides the sheet into a first leaf and a second leaf. The fold along the centerline forms a spine. The spines on the plurality of sheets are disposed adjacent one another. The cohesive is configured to be dry during printing and adhere in response to pressure. The cohesive is disposed on a first cohesive face of the first leaf and a second cohesive face of the second leaf. The first cohesive face of one of the sheets is mated and adhered with the second cohesive face of another sheet. The graphic, text or image is printed on the first and second leaves and expands across the centerline.

### CROSS-REFERENCE TO RELATED APPLICATIONS

This application claims priority under 35 U.S.C. §119(e) to U.S. Provisional Patent Application No. 61/336,481 filed on Jan. 22, 2010. The entire disclosure of U.S. Provisional Patent Application No. 61/336,481 is hereby incorporated herein by reference.

### BACKGROUND OF THE INVENTION

1. Field of the Invention

The present invention relates to a lay-flat book block and method of making a lay-flat book block. Specifically, the present invention is for a lay-flat book block having a lay-flat pre-converted print stock and a method of making the lay-flat book block having the lay-flat pre-converted print stock.

2. Background Information

Pages in both hardback and perfect bound books often do not lay flat when opened. This requires the reader to hold or place pressure on the pages to ensure that the book stays open at the desired page. Many attempts at providing a book that lays flat have been made. One attempt is the use of mechanical binding on a book. The mechanical binding can be a wire spiraled through the spine, such as that shown and described in Canadian Patent No. 1316195.

Other attempts, such as the book binding in U.S. Pat. No. 379,334 provide a book binding wherein a single sheet of paper is folded in multiple locations to form a transverse V-shape fold in the middle of the sheet. Each V-shaped fold on each sheet is bound to a book cover.

Yet another attempt at a lay-flat book is disclosed in U.S. Pat. No. 7,490,960. The lay-flat book has a plurality of pages that are fabricated with notches in alternating patterns. The fabricated pages are printed then assembled using adhesive and hard covers or cloth binding.

The above patents disclose a process wherein the pages are printed followed by application of a means for binding the pages. This does not allow a distributor, consumer or other end-user to receive print stock that is configured to facilitate printing and assembly. In addition, publishers have previously utilized perfect binding or sewing to bind the pages in a book. This involves printing then applying glue or stitching to bind the papers. This limits the ability of publishers to apply a coating to the pages or to print or image large crossover text, graphics or images that take up two pages.

In view of the above, it will be apparent to those skilled in the art from this disclosure that there exists a need for an improved lay-flat book block having lay-flat pre-converted print stock that facilitates coating, printing or imaging, and facilitates the formation of a lay-flat book at a printing establishment. This invention addresses this need in the art as well as other needs, which will become apparent to those skilled in the art from this disclosure.

### SUMMARY OF THE INVENTION

A lay-flay book block according to the present invention is provided that basically includes a stack of pages, a cohesive and a graphic, text or image. Each page includes two sheets of lay-flat pre-converted print stock that are folded along a centerline which divides the sheet into a first leaf and a second leaf. The fold along the centerline forms a spine. The spines on the plurality of sheets are disposed adjacent one another. The cohesive is configured to be dry during printing and adhere in response to pressure. The cohesive is disposed on a first cohesive face of the first leaf and a second cohesive face of the second leaf. The first cohesive face of one of the sheets is mated and adhered with the second cohesive face of another sheet. The graphic, text or image is printed on the first and second leaves and expands across the centerline.

A method of making a lay-flat book block according to the present invention is provided that basically comprises applying a cohesive including a natural rubber latex glue to a cohesive face of a plurality of sheets or roll of print stock; drying the cohesive before printing; cutting the print stock into sheets; printing graphics, text or images on a print face opposite the cohesive face with a printing press; folding the sheets along a centerline to separate into first and second leaves; mating a first cohesive face on the first leaf with a second cohesive face on the second leaf in a stack; and applying pressure to the stack to permanently adhere first and second cohesive faces together.

A method of making a lay-flat book block according to the present invention is also provided that basically comprises receiving lay-flat pre-converted print stock having a cohesive configured to be dry during printing and adhere in response to pressure and disposed on a cohesive face of the print stock; cutting the print stock into sheets; printing a graphic, text or image across a centerline of the sheet which divides the sheet into a first leaf and a second leaf with a digital press; folding the sheets along the centerline; and mating and adhering the first cohesive face of one of the sheets with the second cohesive face of another sheet to form a page.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 illustrates a conventional hardback book;

FIG. 2 illustrates a lay-flat book block in a cover in accordance with an embodiment of the present invention;

FIG. 3 illustrates a pre-converted sheet for the lay-flat book block having a cohesive pattern in accordance with the embodiment of the present invention;

FIG. 4 is a plan view of the pre-converted sheet for the lay-flat book block having faces for printing or imaging in accordance with the embodiment of the present invention;

FIG. 5 is a plan view of the pre-converted sheet for the lay-flat book block having faces for the cohesive pattern in accordance with the embodiment of the present invention;

FIG. 6 is a flow chart of a method of making the lay-flat book block in accordance with an embodiment of the present invention; and

FIG. 7 is a perspective view of two pre-converted sheets for mating of cohesive faces in accordance with the embodiment of the present invention.

### DETAILED DESCRIPTION OF THE PREFERRED EMBODIMENTS

Preferred embodiments of the present invention will now be explained with reference to the drawings. It will be apparent to those skilled in the art from this disclosure that the following description of the embodiments of the present invention is provided for illustration only and not for the purpose of limiting the invention as defined by the appended claims and their equivalents.

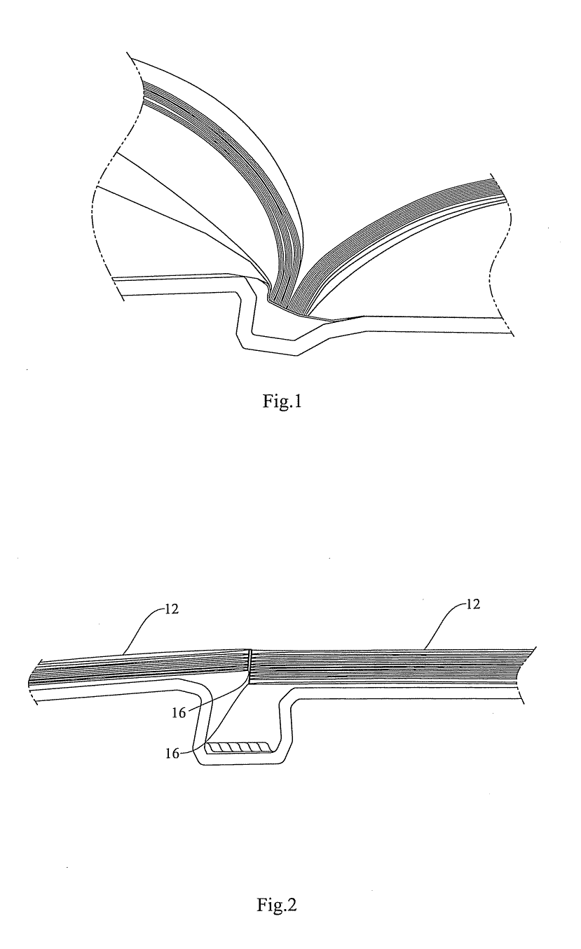

Referring initially to FIG. 1, a conventional hardback book is shown. The conventional hardback book has pages that are bound such that the pages on either side of the binding do not lay flat. Instead, the pages arch upwardly and outwardly. In some cases, the arch is so great that the pages flip over by themselves. The reader must apply pressure or hold the pages down so that the pages do not flip before the reader is done viewing the page.

FIG. 2 illustrates a lay-flat book block 1 of the present invention in an optional cover. The lay-flat book block 1 is made using the inventive method 100 described herein. Specifically, the method 100 utilizes lay-flat pre-converted print stock in the form of sheets 2 to form the lay-flat book block 1 and to facilitate the making of the lay-flat book block 1. The lay-flat book block 1 diminishes the need for perfect binding, commonly used in book publishing.

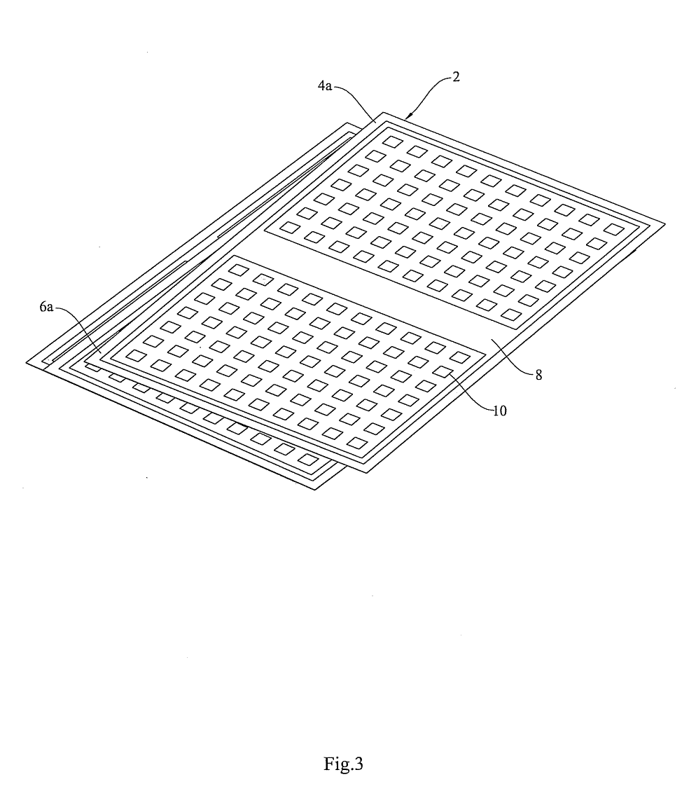

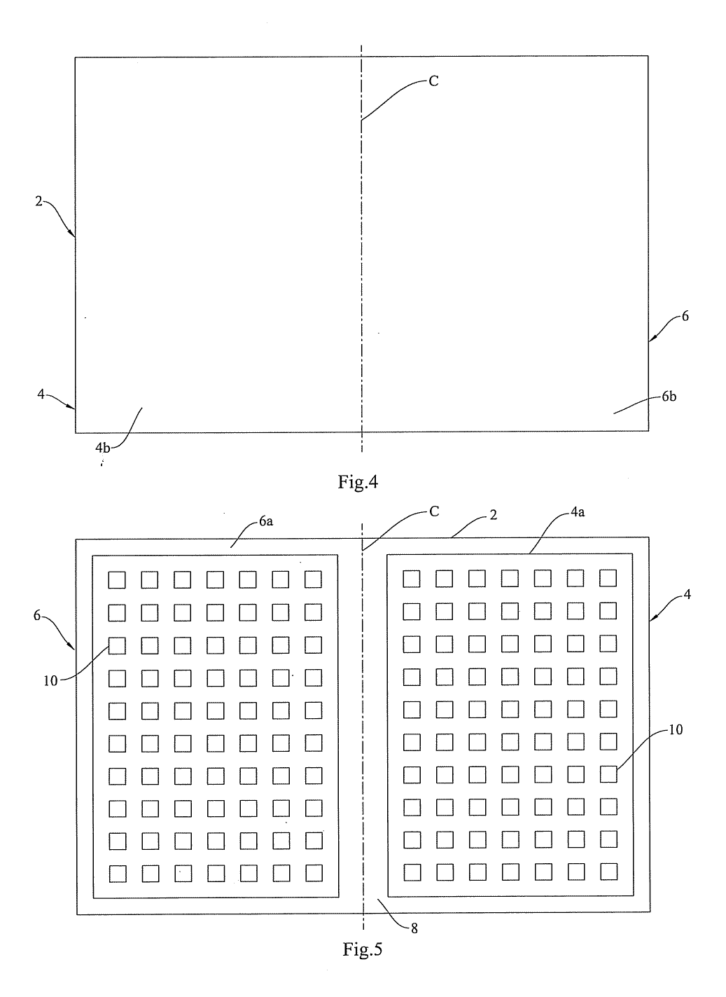

Referring to FIGS. 3-5 and 7, each of the sheets 2 has a centerline C along which the sheet 2 is eventually folded to form a spine. The centerline C separates the sheet 2 into a first leaf 4 and a second leaf 6. The first leaf 4 has a first cohesive face 4a and a first print face 4b that oppose each other. Similarly, the second leaf 6 has a second cohesive face 6a and a second print face 6b that oppose each other.

The first cohesive face 4a and the second cohesive face 6a have cohesive formed thereon. Specifically a border cohesive 8 is applied to the border of the first and second cohesive faces 4a, 6a and along the centerline C of the sheet 2. The border cohesive 8 binds edges of the first leaf 4 to edges of the second leaf 6, as will be described in more detail below. The border cohesive 8 has a predetermined width that widens along the centerline C. The predetermined width is preferably wide enough such that trimming of the sheets 2 can occur as desired and the edges of the first and second leaves 4, 6 are still bound together.

The first and second cohesive faces 4a, 6a also have a plurality of cohesive shapes 10 formed in patterns within a boundary defined by the border cohesive 8. In FIGS. 3, 5 and 7, the shape of the cohesive shapes 10 is that of a square. However, it will be apparent to one of ordinary skill in the art from this disclosure that the shape can be any of a variety of shapes and the pattern formed by the plurality of cohesive shapes 10 can be any of a variety of patterns.

The border cohesive 8 and the cohesive shapes 10 are preferably comprised of the same cohesive. However, the respective cohesive used in the border cohesive 8 and the shape cohesive 10 can differ from one another as the type of paper requires. In another embodiment, cohesive shapes 10 are absent and the border cohesive 8 is applied as one solid layer across the entire first and second cohesive faces 4a, 6a. In yet another embodiment, the border cohesive 8 is absent and the cohesive shapes 10 are applied to the entire first and second cohesive faces 4a, 6a. The border cohesive 8 and the cohesive shapes 10 can comprise various types of cohesive. For example, latex cohesive that is dried with hot air or IR curable cohesive that is dried using infrared can be used. The cohesive is dry or substantially dry when entering the printer and remains so during the printing process. That is, the cohesive is able to withstand heat in a high temperature environment of an industrial digital driven printer, for example, such as those offered by Hewlett-Packard Corp., Xerox Corp., and Eastman Kodak Co. Thus, the cohesive is activated when in contact with other cohesive by pressure, not by moisture, heat, etc. It will be apparent to one of ordinary skill in the art from this disclosure that the border cohesive 8 and the cohesive shapes 10 can comprise other types of cohesive so long as the cohesive has the ability to be dried before printing or imaging and is activated by pressure.

The cohesive used in the border cohesive 8 and the cohesive shapes 10 allows formation of the lay-flat book block 1 after printing or imaging with relative ease by applying pressure, as will be described in more detail below. Furthermore, perfect binding, commonly used in the industry, can be avoided because of the dried border cohesive 8 and cohesive shapes 10 used to create the lay-flat book block 1. In one embodiment, the border cohesive 8 and the cohesive shapes 10 have a cohesive that includes a natural rubber latex glue without a salt additive. Alternatively, the cohesive could include a natural rubber latex glue with a salt additive or the like for IR or RF drying. It will be apparent to one of ordinary skill in the art from this disclosure that one could use another cohesive(s) that is adhesive and adheres only to its complement only when pressure is applied. The cohesive is exposed to the high-temperature environment of the printer without any protective backing to shield the cohesive. The hardness of the cohesive prevents the border cohesive 8 and the cohesive shapes 10 from becoming tacky while printing and also protects the border cohesive 8 and the cohesive shapes 10 when folding of the sheets 2 occurs.

The first and second print faces 4b, 6b are typically left blank and receive images thereon after the cohesive is applied and dried. As used herein, images include text, graphics or photos or a combination thereof. The lay-flat book block 1 advantageously simplifies printing or imaging crossover text, graphics or photos. That is, the entire text, graphics or photos can be printed or imaged across centerline C in both first and second print faces 4b, 6b. Thus, printing or imaging can occur in one pass. Because of the ability to print or image on a side of the sheet 2 and because of stacking the sheets 2 to form the lay-flat book block 1, the present invention diminishes the transverse split down the middle so commonly seen in crossover printing or imaging in conventional publishing.

Furthermore, the sheets 2 can be coated. Specifically, the sheets 2 described above easily lend themselves to the application of matting, semi-matting or gloss, for example, because of the dried cohesive and the ability to print or image consecutive pages on adjacent first and second print faces 4b, 6b. The sheets 2 can even be coated with a UV coating, which is desirable but has been beyond reach in lay-flat books and other post-processed books.

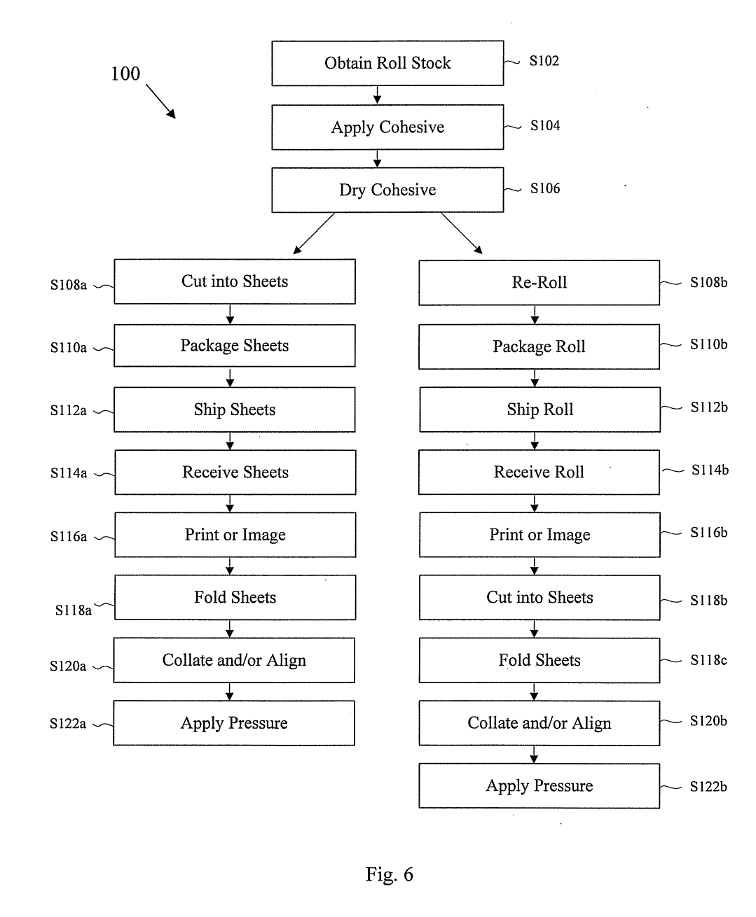

Referring to FIG. 6, a flow chart for a method 100 of making the lay-flat book block 1 is illustrated. A “Fabrication and Pre-conversion” portion of the method 100 will first be described which includes formation of lay-flat, pre-converted print stock. A roll of raw stock in the form of roll stock is obtained. S102 The roll stock can be of various types and weights. The lay-flat book block 1 and method 100 provides flexibility in choosing a type of raw paper stock and allows the use of a wide range of paper stock that can be run on various printing or imaging devices. The lay-flat book block 1 and method 100 can utilize lightweight stock or high weight stock as desired by a publisher. Previously, heavier weight stock had to be used to avoid distortion when both a wet adhesive and printing or imaging, which involves moisture, were applied to paper. The lay-flat book block 1 and method 100 of the present invention includes a cohesive that is dry to the touch at the time of printing or imaging and thus avoids the aforementioned shortcomings so that lighter weight stock can be used. In addition, the paper stock can have various textures and can include grain, synthetic blends, cotton blends or film, for example.

The cohesive is applied to the first and second cohesive faces 4a, 6a, in the form of the border cohesive 8 and the plurality of cohesive shapes 10. S104 The cohesive on the first and second cohesive faces 4a, 6a are dried before printing or imaging such that the cohesive is dry to the touch at the time of printing or imaging. S106. This dried cohesive advantageously allows the sheets 2 to be fed through a printing or imaging device (not shown) for printing or imaging on the first and second print faces 4b, 6b. Basically, the cohesive is configured to be adhesive and adhere only to its complement only when pressure is applied, as will be explained in more detail below.

After application of the cohesive, the unwound, pre-converted web of the roll stock is ready for being cut into the sheets 2. However, often the publisher requests print stock in one of two forms, depending on their machinery. Specifically, some entities desire cut sheets and some desire rolls. The method 100 of the present invention is flexible enough to provide both. Referring to FIG. 6, the unwound, pre-converted web of the roll stock is either cut into sheets 2 (S108a) or is re-rolled (S108b) to provide a pre-converted roll stock. If printing or imaging is to occur at the same location as the pre-conversion, the sheets 2 or pre-converted roll stock is then printed upon.

However, the advantages in the lay-flat book block 1 and method 100 allow printing or imaging to occur off-site or at a location removed from the pre-conversion. An optional “Removed Location” portion of the method 100 will now be described. The fact that the cohesive is dry to the touch and can be fed through the printing or imaging device (not shown) without damage to the cohesive allows formation of the lay-flat book block 1 at a location away from the place of fabrication and pre-conversion. In this portion of the method 100, the pre-converted sheets 2 are stacked and packaged for shipping (S110a) or the pre-converted roll is packaged for shipping (S110b), depending on the request from the removed location. The packaged sheets 2 are then shipped (S112a) or the packaged pre-converted roll is then shipped (S112b) to a location removed from the place of pre-conversion. That is, the sheets 2 or pre-converted roll are shipped and then received by a distributor, printing facility, consumer, or end-user, for example, at a location distant from the place of pre-conversion. (S114a, S114b) Regardless of whether the sheets 2 or pre-converted roll are shipped after pre-conversion, the sheets 2 provide an advantage in that the sheets 2 can be fed through the printing or imaging device with dry cohesive exposed to the high temperature environment of the printer. Thus, the dry cohesive does not interfere with the printing or imaging process and avoids the mess or disorder common with wet cohesives.

A “Printing and Formation” portion of the method 100, which can occur at the place of pre-conversion or remote from the place of pre-conversion, will now be described. After pre-conversion, the sheets 2 or pre-converted roll are arranged for printing and fed into the printing or imaging device, which applies the text, graphics or images on the first and second print faces 4b, 6b of the sheets 2. The printer preferably includes a printing press that includes, for example, a digital press, a digital color press or a conventional press. The cohesive is configured to remain dry or substantially dry when exposed to the hot environment of a digital press during printing. (S116a, S116b) In the case where the pre-converted roll is used, the pre-converted roll is cut into the sheets 2 after printing or imaging. (S118b) The sheets 2 are folded in half along the centerline C, which runs transversely across the sheet 2 then mated. (S118a, S118c)

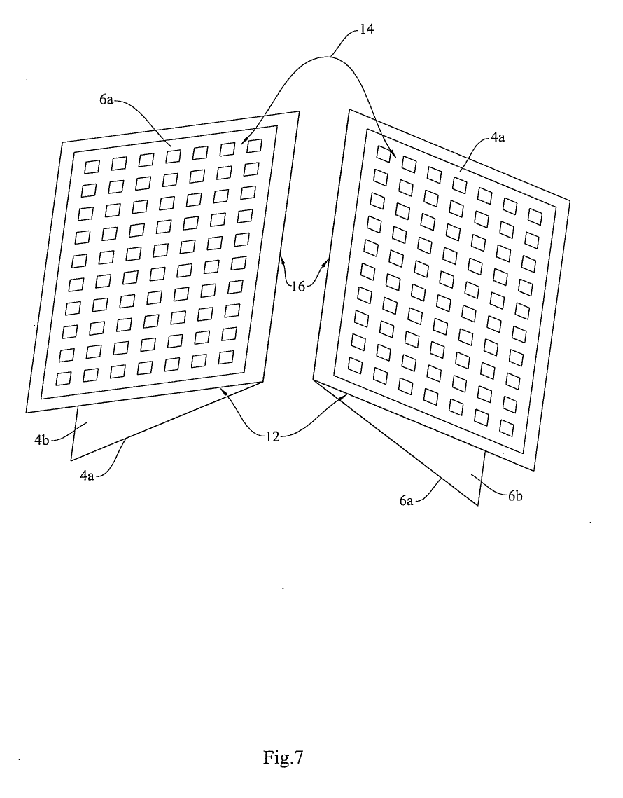

The sheets 2 are then collated and/or stacked. (S120a, S120b) Referring to FIG. 7, two sheets 2 forming one of the pages 12 in the lay-flat book 1 is illustrated. As arrow 14 indicates, collating and/or stacking includes mating the first cohesive face 4a with the second cohesive face 6a. Preferably, the first and second cohesive faces 4a, 6a are directly mated together. However, it will be apparent to one of ordinary skill in the art from this disclosure that a solid intermediary component having the cohesive can be disposed between the pages to add strength or stiffness, for example. The mating and adhering of the first and second cohesive faces 4a, 6a forms the page 12. Thus, the first leaf 4 of one sheet 2 and the second leaf 6 of another sheet 2 are mated and adhered together to form the page 12, thereby forming a “doubled-backed” page 12. That is, each page 12 of the lay-flat book 1 has the first print face 4b on one side and the second print face 6b on the other side. Each of the first and second print faces is from a different sheet 2, i.e., the first print face 4b of one sheet 2 and the second print face 6b of another sheet 2. The process is repeated to form a plurality of pages 12. That is, the downwardly facing first cohesive face 4a of FIG. 7 is mated with the second cohesive face 6a of a preceding sheet 2. Similarly, the downwardly facing second cohesive face 6a of FIG. 7 is mated with the first cohesive face 4a of a subsequent sheet 2.

The present invention advantageously provides dry cohesive that does not adhere without the application of pressure. Thus, the first and second cohesive faces 4a, 6a of the respective plurality of sheets 2 can be mated but not adhered. This advantageously allows alignment of the sheets' edges or jogging of the sheets 2 stacked for forming pages 12. Thus, a benefit of the present invention is that mere mating of the first leaf 4 of one sheet 2 to the second leaf 6 of another sheet 2 does not adhere the first cohesive face 4a and the second cohesive face 6a. This allows the stacked leafs 4, 6, forming the pages 12, to be aligned or jogged before permanently forming the page 12.

Once the sheets 2 forming the pages 12 are properly positioned in a stack, pressure is applied to the stack of folded sheets 2. (S122a, S122b) The pressure causes the border cohesive 8 and the cohesive shapes 10 to permanently adhere to the respective first and second cohesive faces 4a, 6a to form the pages 12 that make up the lay-flat book block 1. The length of time that the pressure is applied and the amount of pressure applied will vary depending on the type of cohesive and the type of paper used. Examples of machinery capable of applying the pressure to activate the cohesive are the G.E.O. Knight Press or the press from a guillotine trimmer. An air-activated press such as the die press from Tippmann Industrial Products Inc., Ft. Wayne, Ind., is also suitable for applying pressure to activate the cohesive. It is also contemplated that a cohesive could be used such that an end-user at home could apply enough pressure to activate the cohesive by use of a tool, body weight or simply pressing down, for example.

Once the lay-flat book block 1 is formed, a cover and end sheets can be applied using conventional means or the cover and end sheets can utilize the border cohesive 8 and cohesive shapes 10 described above.

Referring back to the embodiment shown in FIG. 2, the lay-flat book block 1 and method 100 of the present invention provides a book block formed by stacking and pressure sealing. Repeated folding of sheets 2 along their centerlines C followed by stacking the folded sheets forms the spine in the lay-flay book block 1. As seen in FIG. 2, as the pages 12 are turned, the pages 12 lay flat or substantially flat. Referring to FIGS. 2 and 7, two sheets 2 folded along their centerline C and adhered to form the page 12 also form a spine 16. With each additional sheet 2 to make a subsequent page 12, another spine 16 is formed. The spines 16 of the sheets 2 are disposed adjacent to one another in the lay-flat book block 1. And, as illustrated in FIG. 2, as pages 12 of the lay-flat book block 1 are turned, spines 16 on a first side of the lay-flat book block 1 face spines 16 on a second side of the lay-flat book block 1. In particular, the stack of spines 16 on either side of the opened lay-flat book block 1 form a wall such that when the lay-flat book block 1 is open to a selected page, the walls on either side are substantially parallel to one another. In contrast, referring to FIG. 1, the back of the book gutter in the conventional book faces downwardly toward the spine of the cover. Notably, the pages of the opened conventional book do not form walls of spines formed by pages.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The terms of degree such as “substantially”, “about” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

1. A method of making a lay-flat book block comprising:
applying a cohesive including a natural rubber latex glue to a cohesive face of a plurality of sheets or roll of print stock;
drying the cohesive before printing;
cutting the print stock into sheets;
printing graphics, text or images on a print face opposite the cohesive face with a printing press;
folding the sheets along a centerline to separate into first and second leaves;
mating a first cohesive face on the first leaf with a second cohesive face on the second leaf in a stack; and
applying pressure to the stack to permanently adhere first and second cohesive faces together.

2. The method of claim 1, wherein
the applying a cohesive includes applying a border cohesive adjacent an edge of the cohesive face.

3. The method of claim 2, wherein
the applying pressure includes binding the edge of the cohesive face together.

4. The method of claim 1, wherein
the applying includes applying a shape cohesive on the cohesive face.

5. The method of claim 1, wherein
the printing of the graphics, text or image includes printing in one pass over the sheet.

6. The method of claim 1, further comprising
shipping the print stock to a location where the printing occurs.

7. The method of claim 1, wherein
the cutting includes cutting the print stock after the printing.

8. The method of claim 1, wherein
the printing occurs at a digital press.

9. The method of claim 1, wherein
the printing occurs at a conventional press.

10. A lay-flay book block having a lay-flat pre-converted print stock comprising:
a stack of pages, each page including two sheets of the lay-flat pre-converted print stock, the sheets being folded along a centerline which divides the sheet into a first leaf and a second leaf, the fold along the centerline forming a spine, the spines on the plurality of sheets being disposed adjacent one another;
a cohesive configured to be dry during printing and adhere in response to pressure and disposed on a first cohesive face of the first leaf and a second cohesive face of the second leaf, the first cohesive face of one of the sheets being mated and adhered with the second cohesive face of another sheet; and
a graphic, text or image printed on the first leaf and second leaf and expanding across the centerline.

11. The lay-flat book block of claim 10, wherein
when the stack is opened to a page and the spines form first and second walls, the walls being parallel to one another.

12. The lay-flat book block of claim 10, wherein
the cohesive includes natural rubber latex glue without a salt additive.

13. The lay-flat book block of claim 10, wherein
the cohesive includes natural rubber latex glue having a salt additive.

14. The lay-flat book block of claim 10, wherein
the cohesive includes a cohesive border adjacent an outer edge of the cohesive face.

15. The lay-flat book block of claim 14, wherein
the outer edge of the first and second cohesive faces is bound together by the border.

16. A method of making a lay-flat book block comprising:
receiving lay-flat pre-converted print stock having a cohesive configured to be dry during printing and adhere in response to pressure and disposed on a cohesive face of the print stock;
cutting the print stock into sheets;
printing a graphic, text or image across a centerline of the sheet which divides the sheet into a first leaf and a second leaf with a digital press;
folding the sheets along the centerline; and
mating and adhering the first cohesive face of one of the sheets with the second cohesive face of another sheet to form a page.

17. The method of claim 16, wherein
the cohesive includes natural rubber latex glue without a salt additive.

18. The method of claim 16, wherein
the cohesive includes natural rubber latex glue having a salt additive.
